(19) United States
(12) Patent Application Publication
(10) Pub. No.: US 2005/0082988 A1
(43) Pub. Date: Apr. 21, 2005

(54) Metal-halide lamp

(76) Inventors: Jacques Lunter, Eindhoven (NL); Jannet Henriet Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,164

(22) PCT Filed: Dec. 23, 2002
(86) PCT No.: PCT/IB02/05741

(30) Foreign Application Priority Data
Jan. 15, 2002 (YE) P02075146.7

(51) Int. Cl. H01J 17/20; H01J 61/20; H01J 61/18

(52) U.S. Cl. 313/639; 313/637; 313/638

(57) ABSTRACT

The invention relates to a metal-halide lamp comprising a discharge vessel (3) with a ceramic wall, the discharge vessel (3) enclosing a discharge space which contains an ionizable filling, which filling contains a quantity of halide of Na, Ca and Tl in addition to Hg. According to the invention, the ionizable filling comprises CaI₂ in a molar quantity which lies between 20 and 50% of the total molar quantity of the halides. Preferably, the molar quantity of CaI₂ lies between 25 and 35% of the total molar quantity of the halides.

The invention relates to a metal-halide lamp comprising a discharge vessel with a ceramic wall, the discharge vessel enclosing a discharge space which contains an ionizable filling, which filling, in addition to Hg, contains a quantity of halide of Na, Ca and Tl.

A lamp of the type defined in the opening paragraph is known from WO 99/53 522 (PHN 16.852). The lamp comprises tungsten electrodes. The known lamp combines a high luminous efficacy with good color properties. The known lamp is suitable as a light source for, for example, interior lighting. With this lamp the perception is used to advantage that a good color rendition is possible when Na-halide is used as a filling component of a lamp, and, when the lamp is in operation, there is a strong widening and reversal of the Na emission in the Na-D lines. This requires a high cold spot temperature Tₖₚ in the discharge vessel of at least 1170K (900° C.). When the Na-D lines are reversed and widened, they assume in the spectrum the form of an emission band having two maximums that are Δλ apart. The presence of Ca favorably influences the color rendition index. The requirement of a large value of Tₖₚ entails that the discharge vessel is relatively small, excludes the use of quartz or quartz glass for the wall of the discharge vessel and forces one to use ceramic for the walls of the discharge vessel.

A ceramic wall in the present description and claims is understood to be a wall made from one of the following materials: monocrystalline metal oxide (for example sapphire), densely sintered polycrystalline metal oxide (for example Al₂O₃, YAG), and densely sintered polycrystalline metal nitride (for example AlN).

The filling of the discharge vessel contains, in addition to Na, Ca and Tl, one or more rare-earth metals with which a desired value for the general color rendition index Rₐ≧80 and the color temperature T_{c} is realized. Rare-earth metals in this description and these claims are understood to mean the elements Sc, Y and the lanthanides.

A disadvantage of the known lamp is that blackening of the wall of the discharge vessel occurs comparatively rapidly owing to deposition on the wall of W evaporated from the electrodes. The effect of blackening is enhanced by the relatively small dimensions of the discharge vessel. A further disadvantage of the known lamp is that under the influence of the rare-earth metals present during lamp operation, there is corrosion of parts of the discharge vessel, more particularly the wall. This finally results in a premature end of the lamp life.

The invention has for its object to provide a means for counteracting the above disadvantage. According to the invention, a discharge lamp of the kind mentioned in the opening paragraph is for this purpose characterized in that the ionizable filling comprises CaI₂ in a molar quantity which lies between 20 and 50% of the total molar quantity of the halides.

It has surprisingly been found that the maintenance of the discharge lamps according to the invention is advantageously improved. After 8,000 burning hours the luminous efficacy is approximately 85% as compared to the value at 100 hours. For the known lamp the luminous efficacy after 8,000 burning hours is less than or approximately equal to 80% as compared to the value at 100 hours. Due to the relatively large spectral contribution of Ca both to the red and the blue, a value of Rₐ≧80 is realized for the general color rendition index during lamp life. In addition, a value for the color temperature of T_{c} up to 3500K is realized for the lamps according to the invention. A further advantage is that the formation of stable Ca aluminate compounds is eliminated and that the Ca present causes a W-halide cycle to develop as a result of which also blackening of the wall of the discharge vessel owing to the evaporation of W of the electrodes is strongly counteracted.

In an advantageous embodiment of the lamp according to the invention, the molar quantity of CaI₂ lies between 25 and 35% of the total molar quantity of the halides. The maintenance of the lamps according to this embodiment of the invention is further improved. After 8,000 burning hours the luminous efficacy is approximately 90% as compared to the value at 100 hours. A value of Rₐ≧85 is realized for the general color rendition index during lamp life. The voltage rise and voltage crest factor are good.

A prerequisite for the occurrence of the W-halide cycle is the presence in the discharge vessel of a small quantity of free oxygen. Generally, the quantity of free oxygen originates from contaminations introduced during the manufacture of the lamp and released from the lamp when the lamp is in the operating state. It has also been established that oxygen is released from the ceramic wall material under the influence of reactions with filling components of the discharge vessel. In the case of too small a concentration, it will hardly be possible to sufficiently maintain the W-halide cycle during the operation of the lamp. In the case of too large a concentration there will be, inter alia, corrosion of the W-electrodes.

In a preferred embodiment of the lamp according to the invention, the discharge vessel contains an oxygen dispenser. This has the important advantage that oxygen is introduced into the discharge vessel in a controlled manner. Taking into account the manufacturing accuracy required for the proper operation of the lamp and the consequent scaling down of contaminations, it is quite likely that the concentration with respect to the quantity of O₂ that is released from contaminations will be too small. An additional advantage of the lamp according to the preferred embodiment is that dosing during lamp life becomes possible. In an advantageous embodiment of the lamp according to the invention, the oxygen dispenser contains CaO. CaO is advantageous in that it forms part of the filling of the discharge vessel.

The filling of the discharge vessel may contain, in addition to Na, Ca and Tl, one or more metals, inter alia, for affecting the color properties of the lamp, for example, In. Besides the exclusion of rare-earth metals, the use of Ti, Zr and Hf is less suitable for the filling, because they form relatively stable oxides.

Experiments have shown that a value for Δλ between 12 nm and 60 nm is desired for obtaining good color properties of the lamp. With a value for Tₖₚ in the range between 1200K and 1300K, a desired magnitude for Δλ may generally be possible, while also a maximum temperature of the wall of the discharge vessel up to 1450K can be realized.

These and other aspects of the invention will be explained in more detail with reference to a drawing, in which:

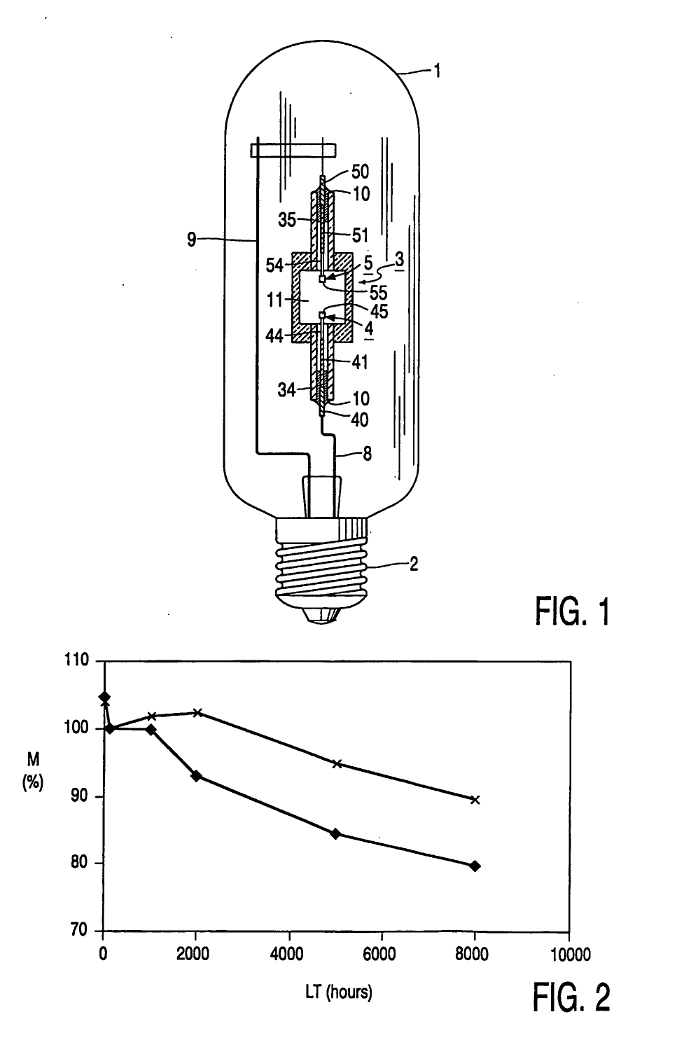

FIG. 1 diagrammatically shows a metal-halide lamp according to the invention with a cut-away view of a discharge vessel, and

FIG. 2 shows a graph of the lumen maintenance as a function of lifetime for the lamp according to the invention as compared to the known lamp.

The Figures are purely diagrammatic and not drawn to scale. Some dimensions are particularly strongly exaggerated for reasons of clarity. Equivalent components have been given the same reference numerals in the Figures whenever possible.

FIG. 1 shows a metal-halide lamp with a cut-away view of a discharge vessel 3, not shown to scale, having a ceramic wall which encloses a discharge space 11, which discharge space contains an ionizable filling which in the case shown contains not only Hg, but also Na, Ca and Tl halide. The filling preferably contains an oxygen dispenser containing CaO, for example in the form of a ceramic CaO-impregnated carrier. Two electrodes 4, 5 having electrode rods 44, 54 and tops 45, 55 each comprised of W are arranged in the discharge vessel. The discharge vessel 3 is closed at least on one side by a ceramic protruding plug 34, 35, which closely surrounds with a clearance a lead 40, 41; 50, 51 respectively, extending into the electrode 4, 5 arranged in the discharge vessel, and is connected thereto in a gastight manner by means of a melt ceramic joint 10 adjacent an end facing away from the discharge vessel. The construction of the discharge vessel is known per se. The discharge vessel is surrounded by an outer bulb 1 having a lamp base 2 at one end. Between the electrodes 4, 5 there is a discharge when the metal-halide lamp is in operation. Electrode 4 is connected via a conductor 8 to a first electric contact which forms part of the lamp base 2. Electrode 5 is connected via a conductor 9 to a second electric contact which forms part of the lamp base 2.

In a practical embodiment of a lamp according to the invention, as described with reference to the drawing, the rated power of the lamp is 70W and the lamp has a rated voltage of 90V. The translucent wall of the discharge vessel has a thickness of approximately 0.8 mm. The inner diameter of the discharge vessel is approximately 6.85 mm, the distance between the electrode tops is approximately 7 mm. According to the invention, the ionizable filling comprises CaI₂ in a molar quantity which lies between 20 and 50% of the total molar quantity of the halides. Preferably, the molar quantity of CaI₂ lies between 25 and 35% of the total molar quantity of the halides. In the example of FIG. 1, the ionizable filling of the lamp contains, in addition to 4.6 mg Hg, 7 mg (Na+Tl+Ca) iodide having a molar percentage composition of 64 mol % Na, 5 mol % Tl and 31 mol % Ca of the total molar quantity of the iodides (the corresponding weight percentage composition is 47.5 weight % Na iodide, 7.5 weight % Tl iodide and 45 weight % Ca iodide). In the known lamp the molar percentage composition of Ca iodide is much higher than that according to the invention. By selecting a substantially lower molar percentage of Ca iodide, surprisingly, the maintenance of the metal-halide lamps is advantageously improved.

The discharge vessel also contains Ar as a start enhancer with a filling pressure of 300 mbar. During the operation of the lamp, Tₖₚ is 1265K. The lamp emits light with a luminous efficacy of 90 lm/W for 100 hours. The color temperature T_{c} of the emitted light is 3150K. The general color rendition index Rₐ is approximately 90.

FIG. 2 shows a graph of the lumen maintenance M (%) as a function of lifetime LT (hours) for the lamp according to the invention as compared to the known lamp. After 8,000 burning hours the luminous efficacy of the lamp according to the invention (indicated by means of the crosses in FIG. 2) is 90% of the value at 100 hours. For the known lamp (indicated by means of the diamond-shaped points in FIG. 2) the luminous efficacy after 8,000 burning hours is less than or approximately equal to 80% as compared to the value at 100 hours.

The scope of protection of the invention is not limited to the exemplary embodiments described hereinabove. The invention is defined by each novel characteristic and all combinations of characteristics. Reference numerals in the claims do not limit the scope of protection thereof. The use of the verb “comprise” and its conjugations does not exclude the presence of elements other than those mentioned in the claims. The use of the indefinite article “a” and “an” preceding an element does not exclude the presence of a plurality of such elements.

1. A metal-halide lamp comprising a discharge vessel (3) with a ceramic wall,
the discharge vessel enclosing a discharge space (11) which contains an ionizable filling,
which filling, in addition to Hg, contains a quantity of halide of Na, Ca and Tl, characterized in that
the ionizable filling comprises CaI2 in a molar quantity which lies between 20 and 50% of the total molar quantity of the halides.

2. A metal-halide lamp as claimed in claim 1, characterized in that the molar quantity of CaI2 lies between 25 and 35% of the total molar quantity of the halides.

3. A lamp as claimed in claim 1, characterized in that the discharge vessel contains an oxygen dispenser.

4. A lamp as claimed in claim 3, characterized in that the oxygen dispenser contains CaO.
